(19) United States
(12) Patent Application Publication
(10) Pub. No.: US 2007/0245933 A1
(43) Pub. Date: Oct. 25, 2007

(54) Projectile-Resistant Partition Construction

(75) Inventors: Georg Kramer, Nordhausen (DE); Klaus Wandler, Rodelsee (DE)

Correspondence Address: AKERMAN SENTERFITT, 801 PENNSYLVANIA AVENUE N.W., SUITE 600, WASHINGTON, DC, 20004, US

(73) Assignee: Knauf Gips KG; Am Bahnhof 7, Iphofen (DE)

(21) Appl. No.: 11/631,476

(22) PCT Filed: Nov. 3, 2005
(86) PCT No.: PCT/EP05/11777

§ 371 Date: Jan. 4, 2007

(30) Foreign Application Priority Data
Nov. 4, 2004 (DE) 20 2004 017 222.4
Dec. 2, 2004 (DE) 20 2004 018 705.1

(51) Int. Cl. E06B 9/00

(52) U.S. Cl. 109/49.5

(57) ABSTRACT

The invention concerns a projectile-resistant partition construction realized as a stand comprising on both sides a single- or multilayer plating (11, 12) with cover plates (13 to 16) and a plurality of stands (17 to 19; 51 to 53) arranged between the plating (11, 12) provided on both sides, where the plating (11, 12) is held directly or indirectly on the stands (17 to 19; 51 to 53), where furthermore bombardment plates (21 to 24) form an extensive projectile barrier (25) in the interior region of the partition construction, and where the bombardment plates (21 to 24) consist at least partly of plaster fiber materials.

### CROSS REFERENCE TO RELATED APPLICATIONS

The present application is a 35 U.S.C. 371 national stage entry of International Patent Application No. PCT/EP2005/011777, filed Nov. 3, 2005, which claims priority from German Patent Application No. DE 20 2004 017 222.4, filed Nov. 4, 2004, and German Patent Application No. DE 20 2004 018 705.1, filed Dec. 2, 2004, the contents of all of which are herein incorporated by reference in their entirety.

### BACKGROUND OF THE INVENTION

1. Field of the Invention

The invention is directed to a projectile-resistant partition construction realized as a stand including on both sides a single- or multilayer plating with cover plates and a plurality of stands arranged between the plating provided on both sides, where the plating is held directly or indirectly on the stands.

2. Description of the Related Art

Projectile-resistant partition construction in the manner of a stand is known in the prior art. In the prior art, massive L-shaped steel plates with folded edges are screwed together as projectile-resistant plates in a specific embodiment. Although steel can provide an appropriate barrier against projectiles, both the transport and assembly of the metal plates of the prior art are expensive and cumbersome.

### SUMMARY OF THE INVENTION

The present invention provides a projectile-resistant partition construction in the manner of a stand that can be easy to transport and simple to assemble while at the same time providing a good projectile barrier.

This invention provides a projectile-resistant partition construction having a stand featuring, on each side, a single- or multi-layer plating with cover plates and a plurality of stands arranged between the plating provided on both sides. According to one embodiment, the plating is held directly or indirectly on the stands, where bombardment plates form an extensive projectile barrier in the interior region of the partition construction and where the bombardment plates are made at least partly of plaster fiber materials.

The present invention provides the projectile-resistant plates that are at least partly made of plaster fiber materials. The projectile-resistant plates are arranged in the interior region of the partition construction, where they form a projectile barrier of extensive surface area. It has been shown that plaster fiber materials exhibit beneficial characteristics when bombarded. Specifically, they effectively prevent the penetration of projectiles, while at the same time minimizing the risk of ricocheting projectiles. Moreover, plaster fiber materials are comparatively lighter than steel, making transport and assembly considerably easier.

In a specific embodiment, the bombardment plates comprise plaster fiber plates with a gross density ranging from 1400 to 1600 kg/m³, preferably 1500 kg/m³ or are made of plaster fiber plates. Plaster fiber plates have also proven themselves in other areas of application and can be manufactured with consistent quality at reasonable costs.

In another embodiment, the bombardment plates can include several layers of different materials, where the several layers can also be durably connected to one another to form a composite body. With a composite body the demands on the material, which vary according to layer depth under circumstances, can be well satisfied. An external layer especially well suited for the impact of the projectile and an internal layer especially well suited for decelerating the projectile can be provided. In a specific embodiment, one layer can be made of plaster fiber and a further layer can be made of at least one sheet metal layer. The bombardment plate is preferably constructed so that the layer of plaster fiber material faces the plating or the presumed direction of entry of a projectile, while the sheet metal in contrast faces away from the plating or the presumed direction of entry of the projectile.

A double layer of bombardment plates is preferably constructed inside the partition construction, where in the case of construction as a multiple layer body, the bombardment plates are arranged with their sheet metal layers facing one another. The bombardment plates arranged in double layers can be connected to each other through a cement fixing worm. Here the bombardment plates, as already mentioned, are either constructed monolithically or as layered elements, particularly as composite bodies. If sheet metal layers are used, these can preferably consist of a steel sheet of a thickness of ≦2 mm, preferably about 1.5 mm (for example steel quality: ST 37).

In a further embodiment of the present invention, the stands are constructed as a simple metal profile or a double metal profile with a respective U-shaped or C-shaped cross section. In this last mentioned specific embodiment, the metal profiles, with their bars facing one another, are arranged either lying directly on one another or with the interposition of strip-like projectile blocks.

In stands with profiled bars, for example, broad beads, it appears appropriate to provide strip-like projectile bars supplementally in the area of the stands. While an extensive projectile barrier between the stands can be ensured through the bombardment plates without any further measures, a residual risk of a projectile penetration would remain in the area of the stands made of metal profiles, since the metal profiles of the stands may not be sufficiently projectile-resistant due to the resulting hollow spaces.

The strip-like projectile barricades can either be installed in parallel orientation to the outer single- or multilayer plating outside on the metal profiles. Alternatively, or additionally, the strip-like projectile barricades can also be interposed between two metal profiles forming a stand. With these interposed strip-like projectile barricades, their outer contour is preferably to be adapted exactly to the outer contour of the adjacent metal profiles.

To facilitate easier assembly, the horizontal junction of two adjacent bombardment plates and/or two strip-like projectile barricades can be constructed in tongue and groove pattern.

According to the desired projectile class, the bombardment plates preferably have a thickness of 10 to 40 mm.

The invention thus creates an arrangement in which a projectile resistance is integrated into an inherently normal stand. This stand wall, with integral projectile resistance, is thus compatible with standard wall systems realized as stands.

The invention provides numerous advantages over and avoids many drawbacks of prior shot-proof separating walls. These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should now become apparent upon a reading of the following detailed description when taken in conjunction with the accompanying drawings, a brief description of which is included below.

### BRIEF DESCRIPTION OF THE DRAWINGS

The invention is explained in greater detail below with regard to further features and advantages on the basis of the description of embodiments and on the basis of the appended drawings, wherein:

FIG. 1 illustrates a horizontal section of an embodiment of an inventive partition construction with simple stand profiles;

FIG. 2 illustrates a horizontal section of an embodiment of an inventive partition construction with double profiles;

FIG. 3 illustrates a horizontal section of a second embodiment of an inventive partition construction;

FIG. 4 illustrates an embodiment of an end enclosure for the partition construction illustrated in FIG. 3.

### DETAILED DESCRIPTION OF THE INVENTION

While specific embodiments of the invention are discussed herein and are illustrated in the drawings appended hereto, the invention encompasses a broader spectrum than the specific subject matter described and illustrated. As would be appreciated by those skilled in the art, the embodiments described herein provide but a few examples of the broad scope of the invention. There is no intention to limit the scope of the invention only to the embodiments described.

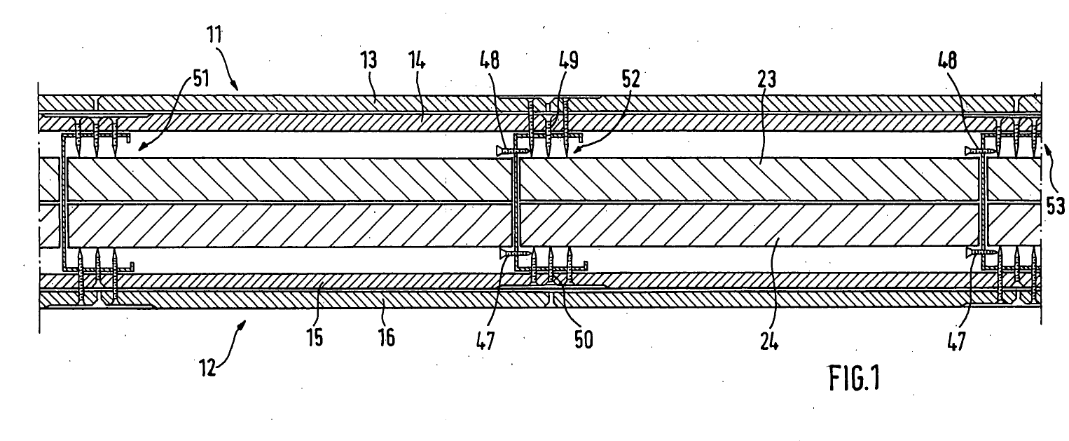

FIG. 1 is a schematic drawing of a horizontal section through a segment of a first embodiment of an inventive partition construction. Cover plates 13 to 16, which form a double-layer external plating 11, 12 are arranged on a plurality of simple stands 51 to 53 arranged in a specific reference grid. In each hollow space of the stand wall, a double layer of bombardment plates 21, 22; 23, 24 is tightly inserted between the adjacent stands 51 to 53 and fixed by the fixing screws 49, 50 of the first layer of the cover plates into position without the screws significantly entering the volume of the bombardment plates 21 to 24. Alternatively, separate fixing screws can be arranged in rows in the stand flange on the head end of the bombardment plates and may present on both sides of the bombardment plates for the purpose of fixing the bombardment plates into position.

In a specific construction, 28 mm thick plaster fiber plates with a raw density of 1500 kg/m³ serving as bombardment plates and simple metal profiles 51 to 53 with a bar height of 75 mm are used to achieve a projectile barrier of class FB 4 according to DIN EN 1522, which corresponds to the highest projectile resistance against projectiles from handguns.

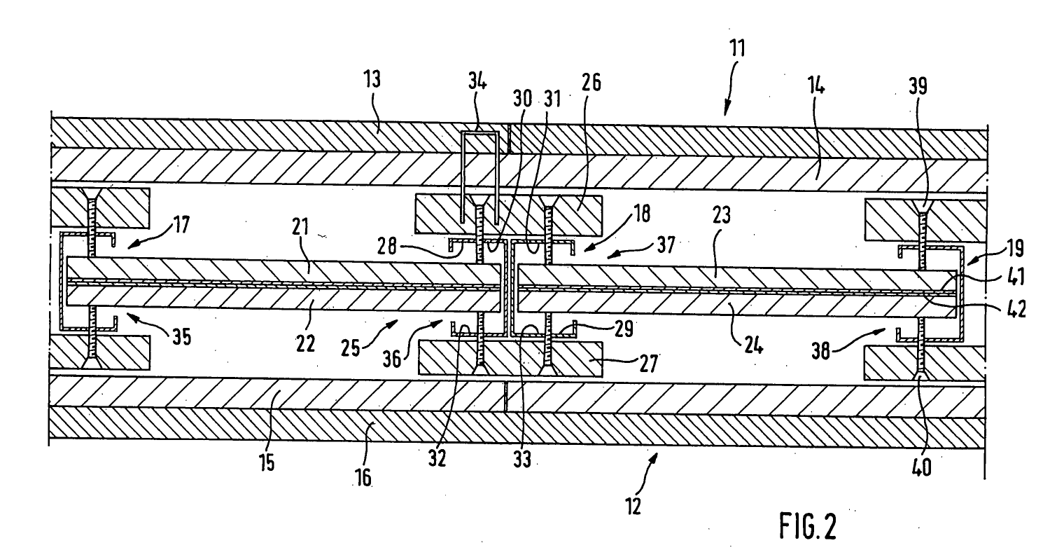

FIG. 2 is a schematic drawing of a horizontal section through a segment according to another embodiment of an inventive partition construction. Cover plates 13 to 16, which form a double-layer external plating 11, 12, are arranged on a plurality of stands 17 to 19 that are arranged on a specified reference grid. In the present embodiment, additional strip-like projectile barricades 26, 27 are interposed between the plating and stands 17 to 19. In the present embodiment, the stands 17 to 19 are formed by two metal profiles of U-shaped or C-shaped cross section and are turned toward each other on the bar side. The respective openings of the C-shaped or U-shaped metal profiles are correspondingly turned away from one another. The metal profiles 28, 29 are oriented so that they are perpendicular to the surface of the outer plating 11, 12. The cover plates of the outer plating are fastened in lateral flange segments, while fixation of the strip-like projectile barricades 26, 27 is realized at the same time, in particular through screws 39, 40 and/or through clamps 34. Specifically, the strip-like projectile barricades 26, 27 can be fastened to the metal profiles 28, 29 through screws 39, 40, whereby the bombardment plates 21 to 24 are fixed at the same time, as is illustrated in greater detail below. The cover plates 13, 14 can then be fastened onto the strip-like projectile barricades 26, 27 through clamps 34. The strip-like projectile barricades are likewise advantageously constructed of plaster fiber plate strips so that fastening through clamps 34 is likewise feasible. Additional or alternative fastening means, in particular screws, can also be used.

In the facing profile openings of the metal profiles 28, 29 of adjacent stands 17 to 19, bombardment plates 21 to 24 are inserted so that in each case a double layer of bombardment plates 21, 22; 23, 24 covers the space between adjacent stands 17 to 19. The bombardment plates 21, 22; 23, 24 lying one upon the other to form a double layer can be fastened to one another using a cement fixing worm 5 to secure the plating 11, 12.

Inside the partition construction, specifically inside the stands 17 to 19, a double layer 21, 22; 23, 24 is fastened by clamping, using screws 39, 40. That is, the screws press the bombardment plates into a fixed position through their ends without significantly entering the volume of the bombardment plates 21 to 24.

In a specific construction, 25 mm thick plaster fiber plates serving as bombardment plates 21 to 24, metal profiles 28, 29 with a width of 75 mm (CW 75) and two sheet metal layers 41, 42 interposed between the bombardment plates 21, 22 and 23, 24 were used to achieve a projectile barrier of class FB 4 according to DIN EN 1522 was attained, which corresponds to the highest projectile resistance against projectiles from handguns.

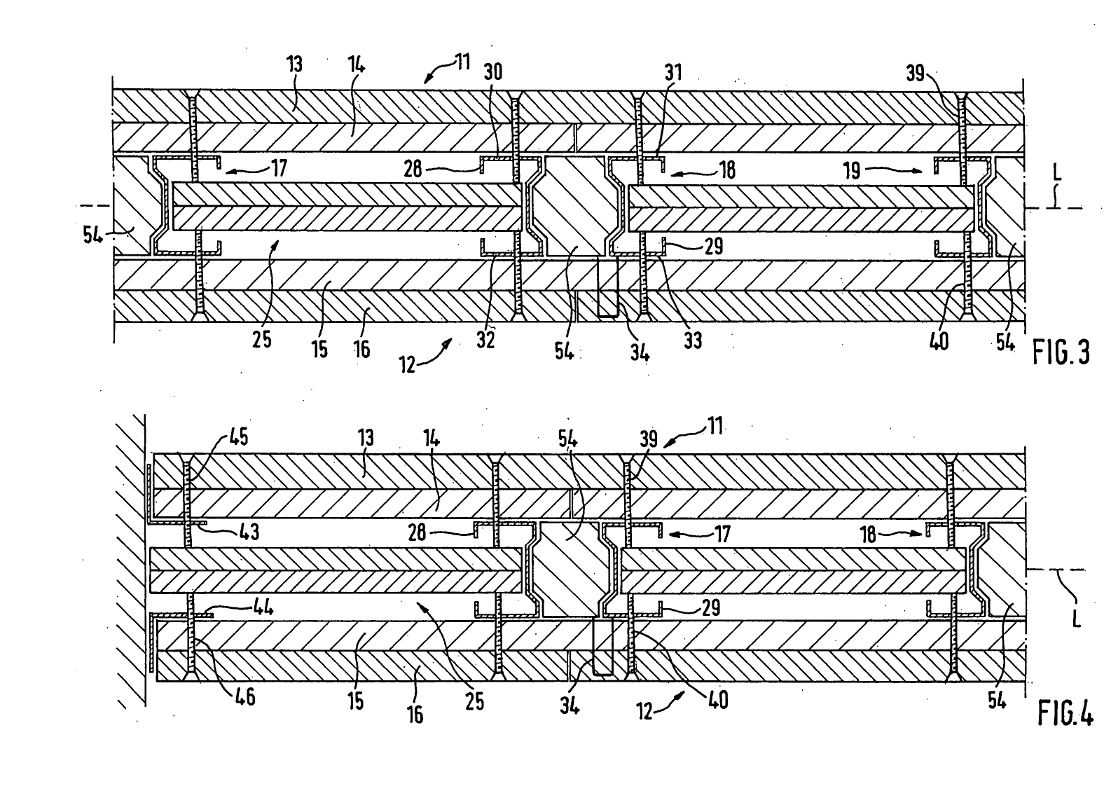

A modified embodiment of a partition construction using stands with marked bar profiling is illustrated in FIG. 3.

In this modified embodiment, the weak point not covered by bombardment plates 21 to 24 in the area of stands 17 to 19 is safeguarded by a strip-like projectile barricade 54 inserted between the metal profiles 28, 29 forming a stand 17 to 19. Correspondingly, with this embodiment, the cover plates 13 to 16 of the plating are directly connected, in particular screwed, to the flange segments 30 to 33 of the metal profiles. The strip-like projectile barricade 54 is also preferably constructed as strips of a plaster fiber plate adapted on the mold side.

FIG. 4 is a schematic illustration of a wall enclosure for the embodiment shown in FIG. 3. Here, instead of a stand, two angle profiles 43, 44 are attached on the wall side to an adjacent wall so that the plating 11, 12 can be fastened to the adjacent wall according to the stand width of stands 17 to 19. The end side bombardment plates 21, 22 are likewise fastened by clamping, using screws 45, 46, analogous to fastening by means of screws 39, 40 to the metal profiles 28, 29 of the stands 17 to 19, as is illustrated in FIG. 1.

Because the plaster fiber material employed for bombardment plates is distinguished by the fact that it is not combustible, there is no reduction in fire protection qualities attainable in connection with customary stand walls. With or without insulation material inserted in the intermediate space, the proposed partition construction is distinguished by high impact absorption properties as well as by good heat insulation.

As a general note, it should be stated that the projectile barrier incorporated into the stand wall does not need to be provided above the overall height of the wall. At a room height of 3.50 m, a projectile barrier or the introduction of bombardment plates 21 to 24 to a height of 2.40 m could be sufficient in individual applications.

While preferred forms of the invention have been disclosed, it will be apparent to those skilled in the art that various changes and modifications may be made that will achieve some of the advantages of the invention without departing from the spirit and scope of the invention. Therefore, the scope of the invention will be determined solely by the appended claims.

1. A projectile resistant partition structure realized as a stand, comprising:
plates that include one or more plate layers, the plates having an exterior surface that opposes an interior surface;
a plurality of stands having an interior portion and an exterior portion, wherein the exterior portion of the plurality of stands is coupled directly or indirectly to the interior surface of the corresponding plate; and
bombardment plates that are coupled to an interior portion of the plurality of stands, wherein the bombardment plates include at least plaster fiber materials.

2. The projectile resistant partition structure as claimed in claim 1, wherein the bombardment plates include plaster fiber plates.

3. The projectile resistant partition structure as claimed in claim 1, wherein the bombardment plates include several layers of different materials, wherein the several layers are coupled to form a composite body.

4. The projectile resistant partition structure as claimed in claim 3, wherein at least one of the several layers are made of plaster fiber material and at least another layer is formed by at least one sheet metal layer.

5. The projectile resistant partition structure as claimed in claim 1, wherein the plurality of stands are constructed as simple metal profiles or as double metal profiles with a respective U-shaped or C-shaped cross section.

6. The projectile resistant partition structure as claimed in claim 1, wherein the bombardment plates are arranged in one or several layers in a center of the partition structure, wherein the center is defined as being proximate to or on a longitudinal central plane.

7. The projectile resistant partition structure as claimed in claim 1, wherein the bombardment plates are engaged by fastening screws of the cover plates or of the projectile barrier.

8. The projectile resistant partition structure as claimed in claim 1, wherein the bombardment plates are coupled to the plurality of stands by fixing screws that are arranged in rows on flanges of the plurality of stands, wherein the fixing screws engage the bombardment plates on opposite sides of the bombardment plates.

9. The projectile resistant partition structure as claimed in claim 1, further comprising strip-like projectile barricades that are provided proximate to the plurality of stands.

10. The projectile resistant partition structure as claimed in claim 9, wherein the strip-like projectile barricades are inserted between adjacent ones of at least the plurality of stands and the plates.

11. The projectile resistant partition structure as claimed in claim 9, wherein the plurality of stands are constructed of multiple parts and the strip-like projectile barricades are integrated between the plurality of stands having multiple-parts.

12. The projectile resistant partition structure as claimed in claim 9, further comprising horizontal junctions between at least two vertically adjacent bombardment plates and two strip-like projectile barricades, wherein the horizontal junctions include a tongue and groove pattern.

13. The projectile resistant partition structure as claimed in claim 1, wherein the bombardment plates have a thickness from 4 to 40 mm.

14. The projectile-resistant partition structure as claimed in claim 1, wherein the bombardment plates are made of plaster fiber plates.
